(19) United States
(12) Patent Application Publication
(10) Pub. No.: US 2002/0078175 A1
(43) Pub. Date: Jun. 20, 2002

(54) Scorecard wizard

(76) Inventors: Thomas Tracy Wallace, Maineville, OH (US); Christopher Charles Glynn, Hamilton, OH (US)

Correspondence Address: GENERAL ELECTRIC COMPANY, ANDREW C HESS, GE AIRCRAFT ENGINES, ONE NEUMANN WAY M/D H17, CINCINNATI, OH, 452156301

(21) Appl. No.: 09/738,360

(22) Filed: Dec. 15, 2000

(51) Int. Cl. G06F 15/16

(52) U.S. Cl. 709/219; 709/218

(57) ABSTRACT

A web-based method and system for monitoring and managing program performance in a real-time manner enhances business reflex. Elements of program performance and structure are maintained and updated on the information platform, and accessible by management and others requiring the information. The information platform is a combination of desktop and spreadsheet technologies that raise the decision making abilities of the business entity. The information platform collects and integrates data from multiple users. The collected and integrated data can be stored, and is retrievable for observation, analysis, and updating by subsequent users.

### BACKGROUND OF THE INVENTION

The present invention relates to program performance monitoring and management in all types of business environments.

Most business programs track program performance on a time-delayed basis. This contributes to costly program delays due to insufficient reaction time and lack of management influence on recovery plans. Business reflex, then, can appear sluggish due to the information lag time.

For example, a business program in today's business environment may typically be monitored on a monthly basis. Business leaders pass around spreadsheets to program leads. The program leads input their data and pass the spreadsheet back. The business lead combines each program “scorecard” into a single set, often by hand. This final spreadsheet is then printed and presented, perhaps as an overhead slide, to decision-making personnel who manage and respond to the program performance.

While essential to the operation of the business, the process is often conducted no more frequently than monthly, due to the extreme maintenance burden of the exercise. This results in out-dated information being passed to management.

It would be desirable, then, to provide a technique for monitoring and managing program performance in a more real-time manner.

### BRIEF SUMMARY OF THE INVENTION

A method and system is proposed for reporting and pulsing program performance between users of a computer communication system. The monitoring and managing of the program performance becomes more accessible and more current. This can be achieved via a business intranet, one or multiple workstations, use of a mainframe system, a computer network, or other suitable means. The program performance is maintained by program leads via simple, easily accessed information platforms, such as web forms. Management and others can access the information as desired, or be designated to immediately be informed when any element of the program performance changes.

Accordingly, the present invention provides a method and system for monitoring and managing program performance in a real-time manner, thereby enhancing business reflex. Elements of program performance and structure are maintained and updated on the information platform, and accessible by management and others requiring the information. The information platform is a combination of desktop and spreadsheet technologies that raise the decision making abilities of the business entity. The information platform collects and integrates data from multiple sources. The collected and integrated data can be stored, and is retrievable for observation, analysis, and updating.

### BRIEF DESCRIPTION OF THE DRAWINGS

FIG. 1 is a schematic block diagram of a program performance reporting and pulsing system that embodies the present invention;

FIG. 2 is a schematic block diagram illustrating screen selections of a system for monitoring and managing business performance;

FIG. 3 is a schematic block diagram illustrating the steps for creating an organization on the system of FIG. 2;

FIG. 4 is a schematic block diagram illustrating tiering menus of the system of FIG. 2; and

FIG. 5 is a schematic block diagram illustrating links to the system of FIG. 2.

### DETAILED DESCRIPTION OF THE INVENTION

Referring to FIG. 1, there is a schematic block diagram 10 illustrating a program monitoring system 10 for reporting and pulsing program performance. The system 10 comprises one or more user computers 12A-12N that are each capable of entering and updating program performance data over a digital communication system. Multiple users can access the digital communication system at a single location, or multiple locations, using one or more workstations, a main frame system, or a computer networking arrangement. The users can collaborate by inputting, accessing, and receiving program performance information, even to the extent of designating users and receivers of the data.

Each computer 12 is capable of transmitting data relating to a defined business activity, as well as storing the data for subsequent retrieval. For example, multiple individual scorecards are provided relating to any given business program. Monitors can be set up for each scorecard, enabling management and others to access and view the scorecards on the inputting computer, or over a network 14. Management and others can also be immediately informed, such as by email, when any scorecard element changes, for better or worse. It is also possible for users to review upcoming critical milestones and performance due dates, without necessarily being specifically designated to receive the information. The digital communication system or network 14 conveys easily accessed web forms to the users at 12, and conveys the information and data provided by the user to a planner 16 and to parts of the organization requiring such access.

Continuing with FIG. 1, the computer communication system can be a network 14, comprising any kind of digital communication network or combination of digital communication networks. For example, the network can include a business intranet, web browser, local area network (LAN), wide area network (WAN), World Wide Web, or any combination of these networks. Likewise, the user computers 12A-12N and planner 16 can be of any form so long as the requests and recommended process sequences can be communicated between the user computer 12 and the planner 16. There may be a single user computer or multiple user computers at multiple locations. In the illustrated embodiment, the network 14 comprises a business intranet. Consequently, the user computer 12 utilizes an intranet web browser to access planner 16, which can be implemented in the form of a web server. In a preferred embodiment, planner 16 provides forms, such as in a spreadsheet arrangement, on which the user inputs data relative to the program of interest.

The planner 16 provides each of the user computers 12A-12N with an interface that permits the user to convey data about the program. The data can be stored, or retrieved for analysis and used in decision-making applications relative to the program. The interface includes an input portion and an output portion. The input portion of the interface is used to convey information from the user's computer to the planner 16. The output portion conveys information from the planner 16 to the user computer and is typically displayed on the monitor of the user's computer. However, the output portion is capable of being displayed on other output peripherals, like printers. Typically, the input information is generated by the user's actuation of an input peripheral, such as a mouse or a keyboard.

In the illustrated embodiment of FIG. 1, the interface is provided by web pages that are defined by the planner 16 to each of the user computers 12A-12N. A web page includes input and/or output portions. The input portion of a web page allows the user to enter information relevant to a program with an input peripheral, such as a mouse or keyboard. The output portion of a web page is used to provide the user with the correct web pages or forms on which to input data. In addition, the output portion of a web page is used to solicit information relevant to the program from a user. In this case, the web page includes both input and output portions, and also reports prior inputs in a logical, easily digested format.

It is also feasible to integrate the planner 16 into one or multiple user computers 12A-12N to create a stand-alone system. In this case, it is feasible to use the network 14 to update the planner 16 resident in each of the computers 12A-12N. The stand-alone system is particularly useful in situations where the integrity or ability to use the network 14 is unreliable. It is also feasible to download the planner 16 to the user computer each time an update or data input is requested from the planner 16. Also, the planner 16 can be client based, or synchronized with a server.

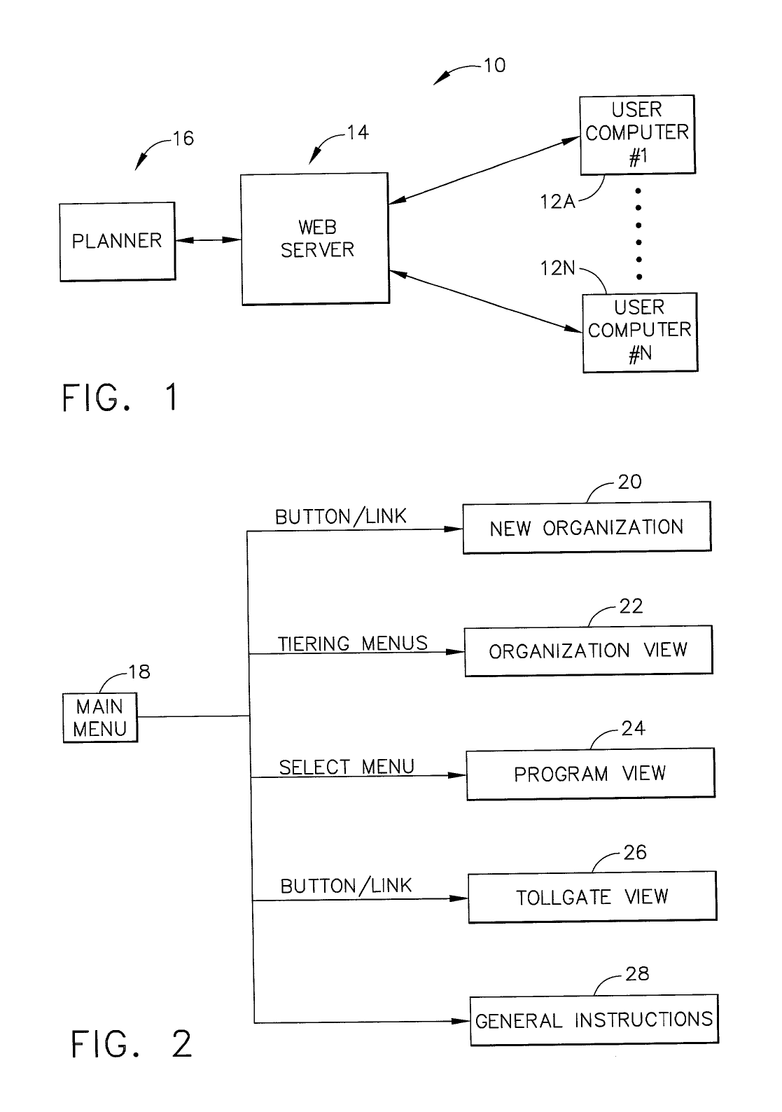

In assembling program performance data via a business intranet, the present invention provides a scorecard that walks the user through a series of menus and links to provide the relevant information about the program. In an exemplary embodiment, illustrated in FIG. 2, the main interface is initially used to provide access to the user. In the illustrated embodiment, a main menu 18 offers menus and links for the user, such as an input screen to set-up a new organization for scorecards at 20. Access to existing program data is also available, by viewing Functional Organization Scorecards at 22 (one function, multiple programs), or Program Scorecards at 24 (one program, multiple functions). Upcoming critical milestones, or Tollgates, can be viewed at 26. Finally, general instructions for the user can be accessed at 28.

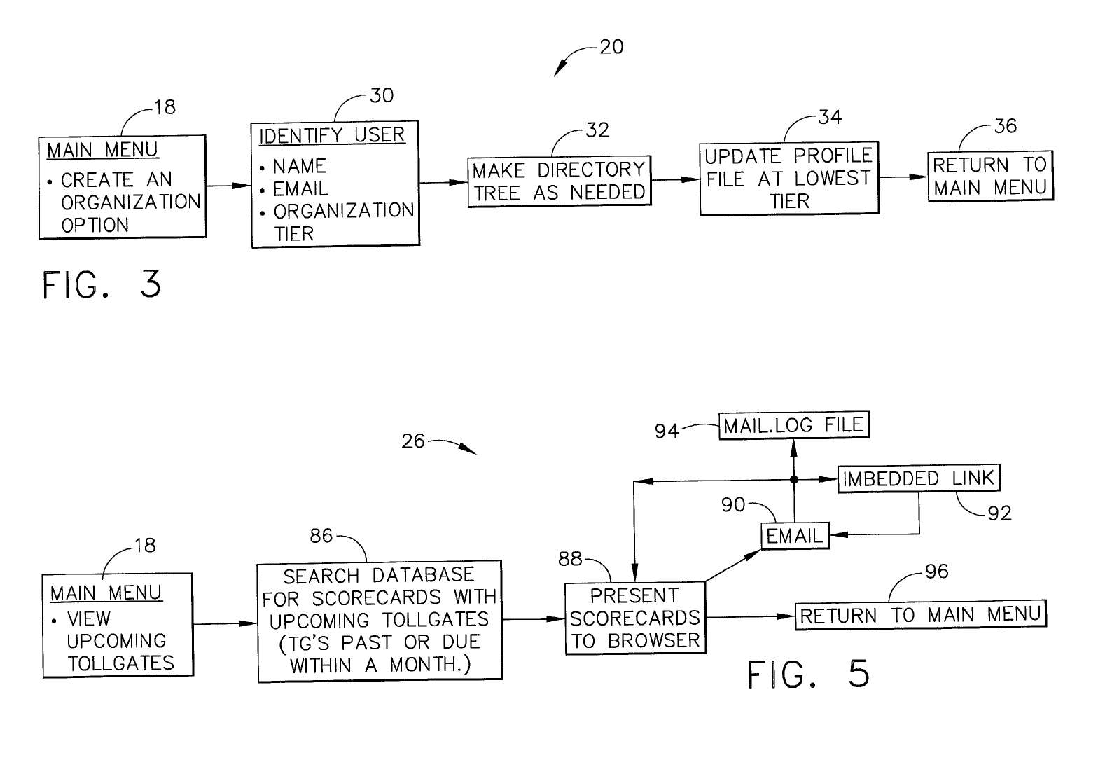

If the user desires to create an organization, the user selects New Organization at 20, from the main menu 18. The user then receives a web page such as is illustrated in FIG. 3, whereby the user is identified at 30, by name, email address, and organization tier (typically by function) structure. A directory tree can be made, as needed, at 32, reflecting the organizational structure. At 34, a profile file can be updated at the lowest organization level or tier. This captures the email, name, and other pertinent identification of the user. On an intranet, this data is used to cross-reference the user identification (login) with his or her name and email. On the internet, cookies or a security login is required to identify the user. Once the organization has been created and the user data gathered, the user can return to the main menu, as indicated by block 36.

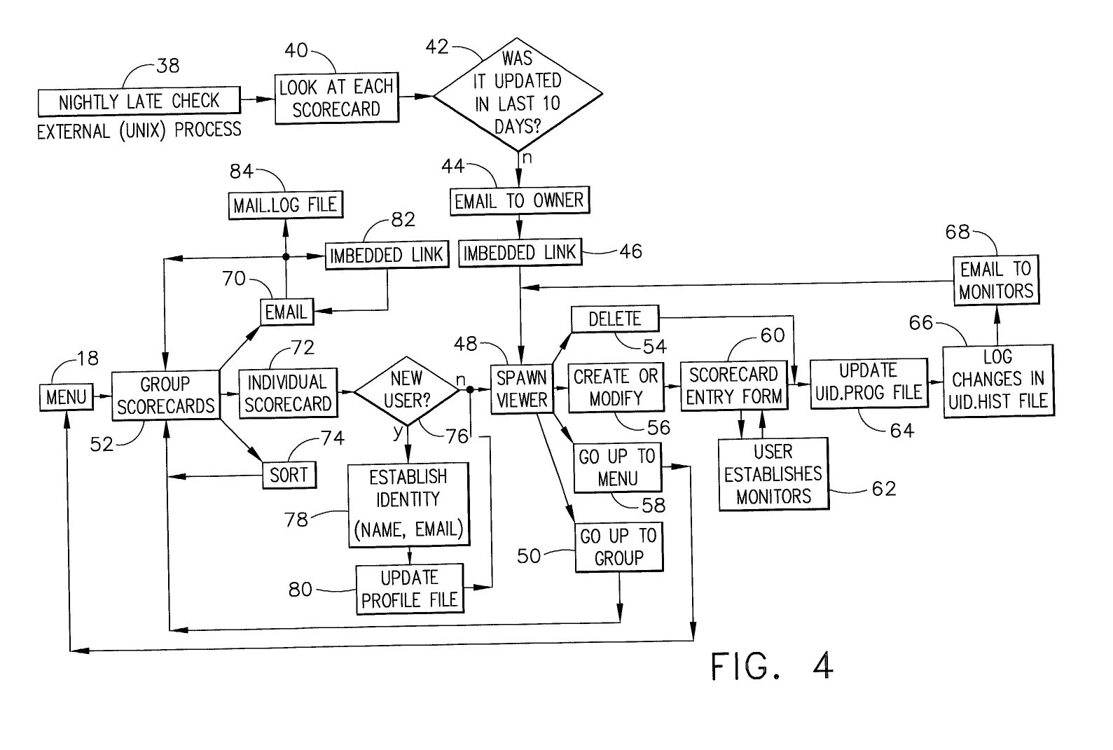

With section views 22 or program views 24 from main menu 18 of FIG. 2, the program follows a series of steps, such as is illustrated in FIG. 4. FIG. 4 illustrates an exemplary series of steps, but it will be understood by those skilled in the art that various steps can be removed or added, without departing from the general concept of the invention. For example, if incentives are needed to get program leads to remember to view their scorecards on a reasonably frequent basis, scorecards can be automatically checked on a predetermined schedule, such as nightly as at block 38, using suitable means such as an autonomous UNIX process. The periodic check confirms whether scorecards have been recently statused, as indicated by block 40 and decision block 42. If so, the program can move to the next card. If not, an email can be spawned to the owner at block 44, containing a direct link 46 to the scorecards required to be viewed 48 and/or updated. The scorecard owner can delete entries 54, create or modify entries 56, go to the main menu 18 as indicated by block 58, or go to a group 50, to view group scorecards 52. If the owner creates or modifies scorecard entries, the scorecard entry form is displayed at 60, allowing the user to establish monitors at 62, before updating the program file at 64. If the viewer elects to delete data at 54, the program skips directly to the update function at 64. After updating the program file at 64, changes are logged into the history file at 66 for later viewing of historical lessons learned activities and performance metrics. The changes are then emailed to the monitors at 68. The user then returns to block 48 where selection choices are repeated.

If the user opts to access section scorecards at block 52, the user can then select to send email at 70, access an individual scorecard at 72, or sort at 74 using some arrangement of column headers, for example, most frequently used of the named column headers. These can include name, program, deliverable, elements (color), last update, or even tollgates. If the user selects email at 70, a textbox is spawned off a link at 82 on the program page as a note to the scorecard owner. Typed text is submitted and piped to email through a collecting common gateway interface (cgi) script, as at 84. The email is preferably in html format for systems where the email client can handle html mime types, and includes a link back to the scorecards. A copy of the email text can be saved on the system for future reference.

If, from the group scorecards block 52, the user accesses an individual scorecard at 72, it is determined at decision block 76 if the user is a new user. If not, the user selects from the choice of scorecard modification options at 54, 56, 58 or 50. If the user is a new user, identity is established at 78 and a profile file is updated at 80, before the user moves to the scorecard modification options of 54, 56, 58 or 50.

Finally, the user can select the link to view upcoming critical milestones, or Tollgates, as shown by 26 of FIG. 1. As illustrated in FIG. 5, when upcoming critical dates are to be viewed, the program searches the database for scorecards with upcoming tollgates, for example tollgates coming up within the next month, and past-due tollgates, at block 86. The scorecards with upcoming and past-due tollgates are presented to the browser, as at block 88. When the scorecards are presented, the viewer can access email capabilities at 90. If the user selects email at 90, a textbox is spawned off a link at 92 on the program page as a note to the scorecard owner. Typed text is submitted and piped to email through a collecting common gateway interface (cgi) script, as at 94. The email is preferably in html format for systems where the email client can handle html mime types, and includes a link back to the scorecards. A copy of the email text can be saved on the system for future reference. Alternatively, or subsequently, the viewer can return to the main menu, as indicated by block 96.

From a server perspective, there are several methods to apply the capability of the present invention. For example, the business organization can be echoed in a directory structure on a web server. The preferred method will be dependent on the anticipated size of the database, access speed, and programmer preference. Anyone with a link to the system is empowered to create a business unit and begin creating scorecards for use and for access by others. Scorecard ownership can be determined by a remote user environment variable, such as a login ID, and stored in an appropriate path in a file containing that ID value or a cookie. All views and emails, then, simply access that database. If necessary, the system can be capable of handling additional security, or limited access control, if the server setup is secure.

While the invention has been described with reference to a preferred embodiment, it will be understood by those skilled in the art that various changes may be made and equivalents may be substituted for elements thereof without departing from the scope of the invention. For example, a database approach can be applied, such as Oracle or Perl DBM hashes. Alternatively, a “flat file” approach can be used to implement the web-based tool of the present invention. The preferred method is at least partially dependent on the anticipated size of the database, access speed, and programmer preference. In addition, many modifications may be made to adapt a particular situation to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for monitoring and managing program performance, the method comprising the steps of:
providing a computer communication system for communicating digital data between at least two users;
allowing at least a first user to use the computer communication system to input data selections and performance data related to program performance;
allowing at least a second user to access the inputted data selections and performance data; and
permitting collaboration between the at least two users relative to the inputted and accessed data selections and performance data.

2. A method as claimed in claim 1 wherein the at least two users are at multiple locations.

3. A method as claimed in claim 1 wherein the computer communication system comprises a computer network.

4. A method as claimed in claim 1 wherein the data selections comprise links and menus for accessing program information and inputting new information.

5. A method as claimed in claim 1 wherein the step of processing comprises the step of using a web server.

6. A method as claimed in claim 5 wherein the web server can be linked to a business intranet.

7. A method as claimed in claim 5 wherein the web server has internet access.

8. A method as claimed in claim 1 wherein the step of allowing at least a second user to access comprises the step of allowing selected monitor users to access program information input by original users.

9. A method as claimed in claim 1 wherein the step of allowing at least a second user to access the inputted data selections and performance data further comprises the step of designating a subsequent user to receive the inputted data selections and performance data.

10. A method of monitoring and managing program performance in a business environment, comprising the steps of:
a. under control of a first system, displaying information identifying selections;
in response to selections made, allowing information to be input by an original user;
b. under control of a second system,
receiving the selectable information and receiving original user input data; and
storing the selectable information and input data for subsequent viewing or response.

11. A method as claimed in claim 10 wherein the first system comprises at least one user computer capable of transmitting data relating to program performance.

12. A method as claimed in claim 10 wherein the second system comprises a web server system.

13. A method as claimed in claim 12 wherein the steps of displaying and receiving comprise the step of accessing the web server system.

14. A method as claimed in claim 10 wherein the steps of displaying and receiving are carried out on a digital communication network.

15. A method as claimed in claim 10 wherein the original user can designate the second system to receive the selectable information and original user input data.

16. A system for monitoring and managing program performance comprising:
a computer network for communicating digital data between at least two users;
means for allowing at least a first user to use the computer network to input data selections and performance data related to program performance;
means for allowing at least a second user to access the inputted data selections and performance data; and
means for permitting collaboration between the at least two users relative to the inputted and accessed data selections and performance data.

17. A system as claimed in claim 16 wherein the at least two users are at multiple locations.

18. A system as claimed in claim 16 wherein the data selections comprise links and menus for accessing program information and inputting new information.

19. A system as claimed in claim 16 wherein the means for processing comprises a web server.

20. A system as claimed in claim 16 wherein the means for conveying comprises means for designating selected users to access program information input by original users.
